(19) United States
(12) Patent Application Publication
(10) Pub. No.: US 2019/0320463 A1
(43) Pub. Date: Oct. 17, 2019

(54) BASE STATION APPARATUS, TERMINAL APPARATUS, AND COMMUNICATION METHOD

(71) Applicants: SHARP KABUSHIKI KAISHA, Sakai City, Osaka (JP); FG Innovation Company Limited, Tuen Mun, New Territories (HK)

(72) Inventors: RYOTA YAMADA, Sakai City (JP); HIROMICHI TOMEBA, Sakai City (JP)

(21) Appl. No.: 16/341,192

(22) PCT Filed: Aug. 29, 2017
(86) PCT No.: PCT/JP2017/030875

§ 371 Date: Apr. 11, 2019

(30) Foreign Application Priority Data
Oct. 18, 2016 (JP) 2016-204152

(51) Int. Cl. H04W 74/08; H04W 72/04; H04W 16/14; H04L 5/00

(52) U.S. Cl. CPC H04W 74/0808; H04W 72/0446; H04L 5/0007; H04W 72/042; H04L 5/0051; H04W 16/14

(57) ABSTRACT

To provide, while achieving coexistence with other radio access systems, a base station apparatus, a terminal apparatus, and a communication method capable of achieving high frequency efficiency. A carrier sense unit configured to secure a channel occupancy time by carrier sense, and a transmission unit configured to transmit at least one subframe in the channel occupancy time are included, and the transmission unit, in a case of communicating with the terminal apparatus only in an unlicensed band, transmits a preamble signal being a common signal in a cell by using an OFDM symbol in an anterior part of a first subframe of the at least one subframe.

### TECHNICAL FIELD

The present invention relates to a base station apparatus, a terminal apparatus, and a communication method.

### BACKGROUND ART

In a communication system such as Long Term Evolution (LTE) or LTE-Advanced (LTE-A) standardized by the Third Generation Partnership Project (3GPP), the communication area can be widened by forming a cellular configuration in which multiple areas, covered by base station apparatuses (base stations, transmission stations, transmission points, downlink transmission devices, uplink reception devices, a group of transmit antennas, a group of transmit antenna ports, component carriers, eNodeB, Access Point, and AP) or transmission stations equivalent to the base station apparatuses, are deployed in the form of multiple cells (Cells) being linked together. A terminal apparatus (reception station, reception point, downlink reception device, uplink transmission device, receive antenna group, receive antenna port group, UE, station, and STA) is connected to the base station apparatus. In such a cellular configuration, frequency efficiency can be improved by using the same frequency among neighboring cells or sectors.

Research and development activities related to the 5th generation mobile radio communication system (5G system) have been actively carried out, aiming to start commercial services around the year 2020. A vision recommendation on the standard system of the 5G system (International mobile telecommunication—2020 and beyond: IMT-2020) was recently reported (see NPL 1) by the International Telecommunication Union Radio Communications Sector (ITU-R), which is an international standardization body.

Securing frequency resources is an important problem for a communication system to deal with rapid increase in data traffic. In the past, a frequency band expected in a communication system providing a cellular service represented by LTE has been a frequency band that is a so-called licensed band for which a license is acquired from a country or a region to which a radio operator provides a service, and available frequency bands are limited.

Accordingly, in these days, a cellular service has been discussed that uses a frequency band that is a so-called unlicensed band that does not need a license from a country or a region. For example, in an LTE system, such a cellular service is specified as Licensed Assisted Access (LAA) (see NPL 2). In a 5G system in which data traffic is expected to increase further rapidly, it is expected that importance of actively utilizing the unlicensed band will increase.

### CITATION LIST

### Non Patent Literature

NPL 1: “IMT Vision—Framework and overall objectives of the future development of IMT for 2020 and beyond”, Recommendation ITU-R M. 2083-0, September 2015.
NPL 2: RP-140259, “Study on Licensed-Assisted Access using LTE”, 3GPP TSG RAN Meeting #63, March 2014.

### SUMMARY OF INVENTION

### Technical Problem

However, the unlicensed band is also shared by other radio access systems represented by a wireless local area network, so it is essential that the 5G system coexists with the other radio access systems to utilize the unlicensed band.

The present invention is made in view of the above circumstances, and an object is, while achieving the coexistence with the other radio access systems, to provide a base station apparatus, a terminal apparatus, and a communication method capable of achieving high frequency efficiency.

### Solution to Problem

To address the above-mentioned drawbacks, a base station apparatus, a terminal apparatus, and a communication method according to the present invention are configured as follows.

A base station apparatus according to an aspect of the present invention is a base station apparatus for communicating with a terminal apparatus, and includes a carrier sense unit configured to secure a channel occupancy time by carrier sense, and a transmission unit configured to transmit at least one subframe in the channel occupancy time, in which the transmission unit, in a case of communicating with the terminal apparatus only in an unlicensed band, transmits a preamble signal being a common signal in a cell by using an OFDM symbol in an anterior part of a first subframe of the at least one subframe.

Additionally, in a base station apparatus according to an aspect of the present invention, the preamble signal includes a cell-specific reference signal and a common downlink control channel.

Additionally, in a base station apparatus according to an aspect of the present invention, the carrier sense unit uses different energy detection threshold values for the carrier sense, between a case of communicating with the terminal apparatus in a licensed band and the unlicensed band, and a case of communicating with the terminal apparatus only in the unlicensed band.

Additionally, a terminal apparatus according to an aspect of the present invention is a terminal apparatus for communicating with a base station apparatus, and includes a radio reception unit configured to receive multiple subframes from the base station apparatus, and a demodulation unit configured to demodulate the multiple subframes received, in which the radio reception unit, in a case of communicating with the base station apparatus only in an unlicensed band, receives a preamble signal being a common signal in a cell by using an OFDM symbol in an anterior part of a first subframe of the multiple subframes, the demodulation unit demodulates a data signal from an OFDM symbol other than the preamble signal, and the preamble signal includes a cell-specific reference signal and a common downlink control channel.

Additionally, a communication method according to an aspect of the present invention is a communication method of a base station apparatus for communicating with a terminal apparatus, and includes the steps of securing a channel occupancy time by carrier sense, and transmitting at least one subframe in the channel occupancy time, in which the transmitting includes, in a case of communicating with the terminal apparatus only in an unlicensed band, transmitting a preamble signal being a common signal in a cell by using an OFDM symbol in a anterior part of a first subframe of the at least one subframe.

Additionally, a communication method according to an aspect of the present invention is a communication method of a terminal apparatus for communicating with a base station apparatus, and includes the steps of wirelessly receiving multiple subframes from the base station apparatus, and demodulating the multiple subframes received, in which the wirelessly receiving includes, in a case of communicating with the base station apparatus only in an unlicensed band, receiving a preamble signal being a common signal in a cell by using an OFDM symbol in an anterior part of a first subframe of the multiple subframes, the demodulating includes demodulating a data signal from an OFDM symbol other than the preamble signal, and the preamble signal includes a cell-specific reference signal and a common downlink control channel.

### Advantageous Effects of Invention

According to the present invention, while achieving coexistence with other radio access systems, it is possible to achieve high frequency efficiency.

### BRIEF DESCRIPTION OF DRAWINGS

FIG. 1 is a diagram illustrating an example of a communication system according to the present embodiment.

FIG. 2 is a diagram illustrating an example of an initial access procedure according to the present embodiment.

FIG. 3 is a block diagram illustrating a configuration example of a base station apparatus according to the present embodiment.

FIG. 4 is a block diagram illustrating a configuration example of a terminal apparatus according to the present embodiment.

### DESCRIPTION OF EMBODIMENT

A communication system according to the present embodiment includes a base station apparatus (a transmission unit, a cell, a transmission point, a group of transmit antennas, a group of transmit antenna ports, a component carrier, eNodeB) and a terminal apparatus (a terminal, a mobile terminal, a reception point, a reception terminal, a reception device, a group of receive antennas, a group of receive antenna ports, UE). Further, the base station apparatus connected with the terminal apparatus (a radio link is established) is referred to as a serving cell.

The base station apparatus and the terminal apparatus according to the present embodiment can communicate in a frequency band for which a license is required (licensed band) and/or a frequency band for which a license is not required (unlicensed band).

According to the present embodiment, “X/Y” includes the meaning of “X or Y”. According to the present embodiment, “X/Y” includes the meaning of “X and Y”. According to the present embodiment, “X/Y” includes the meaning of “X and/or Y”.

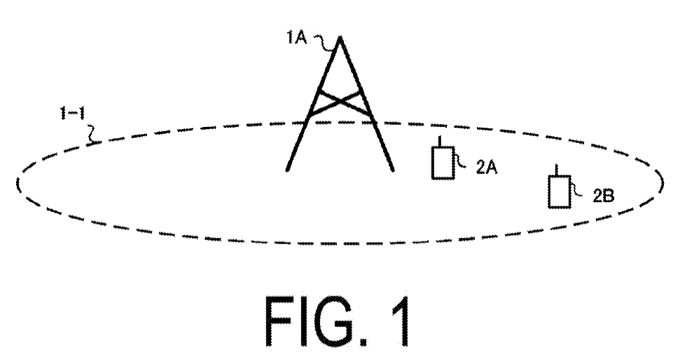

FIG. 1 is a diagram illustrating an example of a communication system according to the present embodiment. As illustrated in FIG. 1, the communication system according to the present embodiment includes a base station apparatus 1A and terminal apparatuses 2A and 2B. Coverage 1-1 is a range (a communication area) in which the base station apparatus 1A can connect to the terminal apparatuses. The terminal apparatuses 2A and 2B are also collectively referred to as terminal apparatuses 2.

With respect to FIG. 1, the following uplink physical channels are used for uplink radio communication from the terminal apparatus 2A to the base station apparatus 1A. The uplink physical channels are used for transmitting information output from a higher layer.
Physical Uplink Control CHannel (PUCCH)
Physical Uplink Shared CHannel (PUSCH)
Physical Random Access CHannel (PRACH)

PUCCH is used to transmit Uplink Control Information (UCI). The uplink control information includes a positive ACKnowledgement (ACK) or a Negative ACKnowledgement (NACK) (ACK/NACK) for downlink data (a downlink transport block or a DownLink-Shared CHannel (DL-SCH)). ACK/NACK for the downlink data is also referred to as HARQ-ACK or HARQ feedback.

Here, the uplink control information includes Channel State Information (CSI) for the downlink. The uplink control information includes a Scheduling Request (SR) used to request an UpLink-Shared CHannel (UL-SCH) resource. The channel state information refers to a Rank Indicator (RI) specifying a suited spatial multiplexing number, a Precoding Matrix Indicator (PMI) specifying a suited precoder, a Channel Quality Indicator (CQI) specifying a suited transmission rate, a CSI-Reference Signal (RS) Resource Indication (CRI) indicating a suited CSI-RS resource, and the like.

The Channel Quality Indicator (hereinafter, referred to as a CQI value) can be a suited modulation scheme (e.g., QPSK, 16QAM, 64QAM, 256QAM, or the like) and a suited coding rate in a predetermined band (details of which will be described later). The CQI value can be an index (CQI Index) determined by the above change scheme, coding rate, and the like. The CQI value can take a value determined beforehand in the system.

The rank indicator and the precoding quality indicator can take the values determined beforehand in the system. Each of the rank indicator, the precoding matrix indicator, and the like can be an index determined by the number of spatial multiplexing, precoding matrix information, or the like. Note that values of the rank indicator, the precoding matrix indicator, and the channel quality indicator are collectively referred to as CSI values.

PUSCH is used for transmission of uplink data (an uplink transport block, UL-SCH). Furthermore, PUSCH may be used for transmission of ACK/NACK and/or channel state information along with the uplink data. In addition, PUSCH may be used to transmit the uplink control information only.

PUSCH is used to transmit an RRC message. The RRC message is a signal/information that is processed in a Radio Resource Control (RRC) layer. Further, PUSCH is used to transmit a MAC Control Element (CE). Here, MAC CE is a signal/information that is processed (transmitted) in a Medium Access Control (MAC) layer.

For example, a power headroom may be included in MAC CE and may be reported via PUSCH. In other words, a MAC CE field may be used to indicate a level of the power headroom.

PRACH is used to transmit a random access preamble.

In the uplink radio communication, an UpLink Reference Signal (UL RS) is used as an uplink physical signal. The uplink physical signal is not used for transmission of information output from higher layers, but is used by the physical layer. The uplink reference signal includes a DeModulation Reference Signal (DMRS) and a Sounding Reference Signal (SRS).

DMRS is associated with transmission of PUSCH or PUCCH. For example, the base station apparatus 1A uses DMRS in order to perform channel compensation of PUSCH or PUCCH. SRS is not associated with the transmission of PUSCH or PUCCH. For example, the base station apparatus 1A uses SRS to measure an uplink channel state.

In FIG. 1, the following downlink physical channels are used for the downlink radio communication from the base station apparatus 1A to the terminal apparatus 2A. The downlink physical channels are used for transmitting information output from the higher layer.
Physical Broadcast CHannel (PBCH)
Physical Control Format Indicator CHannel (PCFICH)
Physical Hybrid automatic repeat request Indicator CHannel (PHICH)
Physical Downlink Control CHannel (PDCCH)
Enhanced Physical Downlink Control CHannel (EPDCCH)
Physical Downlink Shared CHannel (PDSCH)

PBCH is used for broadcasting a Master Information Block (MIB, a Broadcast CHannel (BCH)) that is shared by the terminal apparatuses. PCFICH is used for transmission of information indicating a region (e.g., the number of Orthogonal Frequency Division Multiplexing (OFDM) symbols) to be used for transmission of PDCCH.

PHICH is used for transmission of ACK/NACK with respect to uplink data (a transport block, a codeword) received by the base station apparatus 1A. In other words, PHICH is used for transmission of a HARQ indicator (HARQ feedback) indicating ACK/NACK with respect to the uplink data. Note that ACK/NACK is also called HARQ-ACK. The terminal apparatus 2A reports ACK/NACK having been received to a higher layer. ACK/NACK refers to ACK indicating a successful reception, NACK indicating an unsuccessful reception, and DTX indicating that no corresponding data is present. In a case that PHICH for uplink data is not present, the terminal apparatus 2A reports ACK to a higher layer.

PDCCH and EPDCCH are used to transmit Downlink Control Information (DCI). Here, multiple DCI formats are defined for transmission of the downlink control information. In other words, a field for the downlink control information is defined in a DCI format and is mapped to information bits.

For example, as a DCI format for the downlink, DCI format 1A to be used for the scheduling of one PDSCH in one cell (transmission of a single downlink transport block) is defined.

For example, the DCI format for the downlink includes the downlink control information such as information of PDSCH resource allocation, information of a Modulation and Coding Scheme (MCS) for PDSCH, a TPC command for PUCCH, and the like. Here, the DCI format for the downlink is also referred to as downlink grant (or downlink assignment).

Furthermore, for example, as a DCI format for the uplink, DCI format 0 to be used for the scheduling of one PUSCH in one cell (transmission of a single uplink transport block) is defined.

For example, the DCI format for the uplink includes the uplink control information such as information of PUSCH resource allocation, information of MCS for PUSCH, a TPC command for PUSCH, and the like. Here, the DCI format for the uplink is also referred to as uplink grant (or uplink assignment).

Further, the DCI format for the uplink can be used to request downlink Channel State Information (CSI), which is also called reception quality information.

The DCI format for the uplink can be used for a configuration indicating an uplink resource to which a channel state information report (CSI feedback report) is mapped, the channel state information report being fed back to the base station apparatus by the terminal apparatus. For example, the channel state information report can be used for a configuration indicating an uplink resource for periodically reporting Channel State Information (periodic CSI). The channel state information report can be used for a mode configuration (CSI report mode) to periodically report the channel state information.

For example, the channel state information report can be used for a configuration indicating an uplink resource to report aperiodic Channel State Information (aperiodic CSI). The channel state information report can be used for a mode configuration (CSI report mode) to aperiodically report the channel state information. The base station apparatus can configure any one of the periodic channel state information report and the aperiodic channel state information report. In addition, the base station apparatus can configure both the periodic channel state information report and the aperiodic channel state information report.

The DCI format for the uplink can be used for a configuration indicating a type of the channel state information report that is fed back to the base station apparatus by the terminal apparatus. The type of the channel state information report includes wideband CSI (e.g., Wideband CQI), narrowband CSI (e.g., Subband CQI), and the like.

In a case where a PDSCH resource is scheduled in accordance with the downlink assignment, the terminal apparatus receives downlink data on the scheduled PDSCH. In a case where a PUSCH resource is scheduled in accordance with the uplink grant, the terminal apparatus transmits uplink data and/or uplink control information on the scheduled PUSCH.

PDSCH is used for transmission of downlink data (a downlink transport block, DL-SCH). PDSCH is used to transmit a system information block type 1 message. The system information block type 1 message is cell-specific information.

PDSCH is used to transmit a system information message. The system information message includes a system information block X other than the system information block type 1. The system information message is cell-specific information.

PDSCH is used to transmit an RRC message. Here, the RRC message transmitted from the base station apparatus may be shared by multiple terminal apparatuses in a cell. Further, the RRC message transmitted from the base station apparatus 1A may be a dedicated message to a given terminal apparatus 2 (also referred to as dedicated signaling). In other words, user-equipment-specific information (unique to user equipment) is transmitted using a message dedicated to the given terminal apparatus. PDSCH is used for transmission of MAC CE.

Here, the RRC message and/or MAC CE is also referred to as higher layer signaling.

PDSCH can be used to request downlink channel state information. PDSCH can be used for transmission of an uplink resource to which the channel state information report (CSI feedback report) is mapped, the channel state information report being fed back to the base station apparatus by the terminal apparatus. For example, the channel state information report can be used for a configuration indicating an uplink resource for periodically reporting Channel State Information (periodic CSI). The channel state information report can be used for a mode configuration (CSI report mode) to periodically report the channel state information.

The type of the downlink channel state information report includes wideband CSI (e.g., Wideband CSI) and narrowband CSI (e.g., Subband CSI). The wideband CSI calculates one piece of channel state information for the system band of a cell. The narrowband CSI divides the system band in predetermined units, and calculates one piece of channel state information for each division.

In the downlink radio communication, a Synchronization signal (SS) and a DownLink Reference Signal (DL RS) are used as downlink physical signals. The downlink physical signals are not used for transmission of information output from the higher layers, but are used by the physical layer.

The synchronization signal is used for the terminal apparatus to take synchronization in the frequency domain and the time domain in the downlink. The downlink reference signal is used for the terminal apparatus to perform channel compensation on a downlink physical channel. For example, the downlink reference signal is used for the terminal apparatus to calculate the downlink channel state information.

Here, the downlink reference signals include a Cell-specific Reference Signal (CRS), a UE-specific Reference Signal ((URS) or a terminal apparatus-specific reference signal) relating to PDSCH, a DeModulation Reference Signal (DMRS) relating to EPDCCH, a Non-Zero Power Channel State Information-Reference Signal (NZP CSI-RS), and a Zero Power Channel State Information-Reference Signal (ZP CSI-RS).

CRS is transmitted in all bands of a subframe and is used to perform demodulation of PBCH/PDCCH/PHICH/PCFICH/PDSCH. URS relating to PDSCH is transmitted in a subframe and a band that are used for transmission of PDSCH to which URS relates, and is used to demodulate PDSCH to which URS relates.

DMRS relating to EPDCCH is transmitted in a subframe and a band that are used for transmission of EPDCCH to which DMRS relates. DMRS is used to demodulate EPDCCH to which DMRS relates.

A resource for NZP CSI-RS is configured by the base station apparatus 1A. The terminal apparatus 2A performs signal measurement (channel measurement), using NZP CSI-RS. A resource for ZP CSI-RS is configured by the base station apparatus 1A. With zero output, the base station apparatus 1A transmits ZP CSI-RS. The terminal apparatus 2A performs interference measurement in a resource to which NZP CSI-RS corresponds, for example.

A Multimedia Broadcast multicast service Single Frequency Network (MBSFN) RS is transmitted in all bands of the subframe used for transmitting PMCH. MBSFN RS is used to demodulate PMCH. PMCH is transmitted on the antenna port used for transmission of MBSFN RS.

Here, the downlink physical channel and the downlink physical signal are also collectively referred to as a downlink signal. The uplink physical channel and the uplink physical signal are also collectively referred to as an uplink signal. The downlink physical channels and the uplink physical channels are collectively referred to as physical channels. The downlink physical signals and the uplink physical signals are also collectively referred to as physical signals.

BCH, UL-SCH, and DL-SCH are transport channels. Channels used in the Medium Access Control (MAC) layer are referred to as transport channels. A unit of the transport channel used in the MAC layer is also referred to as a Transport Block (TB) or a MAC Protocol Data Unit (PDU). The transport block is a unit of data that the MAC layer delivers to the physical layer. In the physical layer, the transport block is mapped to a codeword, and coding processing or the like is performed for each codeword.

Further, the base station apparatus can integrate multiple Component Carriers (CC) for broadband transmission to communicate with the terminal apparatus supporting Carrier Aggregation (CA). In the carrier aggregation, one Primary Cell (PCell) and one or multiple Secondary Cells (SCell) are configured as a set of serving cells.

Additionally, in Dual Connectivity (DC), as a group of serving cells, a Master Cell Group (MCG) and a Secondary Cell Group (SCG) are configured. MCG is configured with PCell and optional one or multiple SCells. Further, SCG is configured with a Primary SCell (PSCell) and optional one or multiple SCells.

The base station apparatus can communicate using a radio frame. The radio frame is configured with multiple subframes (sub sections). In a case that a frame length is expressed as time, for example, a radio frame length can be 10 milliseconds (ms), and a subframe length can be 1 ms. In this example, the radio frame is configured with 10 subframes.

The base station apparatus/terminal apparatus can communicate in an unlicensed band. The base station apparatus/terminal apparatus can communicate using PCell operating in a licensed band and at least one SCell operating in an unlicensed band by using the carrier aggregation. Additionally, the base station apparatus/terminal apparatus can communicate using the dual connectivity in which a master cell group communicates in a licensed band, and a secondary cell group communicates in an unlicensed band. Additionally, the base station apparatus/terminal apparatus can communicate in an unlicensed band by only using PCell. Additionally, the base station apparatus/terminal apparatus can communicate only in an unlicensed band by using CA or DC. Note that, communication, for which a licensed band is used as PCell, and a cell (SCell, PSCell) in an unlicensed band is assisted by PCell, for example, by using CA, DC, or the like, is also referred to as a Licensed-Assisted Access (LAA). Further, communication by the base station apparatus/terminal apparatus only in an unlicensed band is also referred to as an UnLicensed-Standalone Access (ULSA). Further, communication by the base station apparatus/terminal apparatus only in a licensed band is also referred to as a Licensed Access (LA).

A radio frame can have multiple frame structures. For example, a Frame structure Type 1, a Frame structure Type 2, and a Frame structure Type 3 are defined. The Frame structure Type 1 is used for Frequency Division Duplex (FDD). In FDD, 10 subframes are used for the downlink. Additionally, in FDD, 10 subframes are used for the uplink. Further, the uplink and the downlink are divided into different frequency domains. The Frame structure Type 2 is used for Time Division Duplex (TDD). In TDD, 10 subframes are used for the uplink and the downlink. The Frame structure Type 3 is used for communication in an unlicensed band. In the Frame structure Type 3, 10 subframes in a radio frame are used for transmission in the downlink or the uplink. Downlink/uplink transmission can occupy one or multiple contiguous subframes. Further, in the downlink/uplink transmission, from any position in a subframe (time, OFDM/SC-FDMA symbol, etc.) transmission can be started. Further, in the downlink/uplink transmission, at any position in a subframe (time, OFDM/SC-FDMA symbol, etc.) transmission can be ended.

In a case of communicating in an unlicensed band, the base station apparatus and/or the terminal apparatus according to the present embodiment needs to perform Listen Before Talk (LBT) in which whether other communication apparatuses are communicating or not is evaluated by carrier (channel) sense before transmission. The base station apparatus/terminal apparatus can occupy a channel for a certain period of time, after LBT. LBT includes performing the carrier sense for a fixed period of time. Additionally, LBT includes performing the carrier sense for a random period of time. A maximum value of a period of time for which a channel can be occupied (channel occupancy time) is referred to as a Maximum Channel Occupancy Time (MCOT). Further, MCOT changes according to data priority. The data priority can be expressed by priority classes (channel access priority classes). The priority classes are denoted as 1, 2, 3, and 4 in a descending order of priority. Additionally, a maximum value of a random period of time necessary for LBT can change according to the priority classes.

In a case of communicating using a carrier in an unlicensed band, the base station apparatus configures an energy detection threshold value such that the energy detection threshold value is equal to or less than a maximum energy detection threshold value. The energy detection threshold value is used, in a case of performing the carrier sense, to determine whether other communication apparatuses are communicating or not (idle or busy). The maximum energy detection threshold value is different depending on whether other technologies sharing the carrier exist or not. Here, a maximum energy detection threshold value in a case that other technologies exist is also referred to as a first threshold value, and a maximum energy detection threshold value in a case that other technologies do not exist is also referred to as a second threshold value. The first threshold value is larger than the second threshold value. Additionally, the second threshold value changes depending on a bandwidth, transmit power, or the like. In a case that multiple carriers are transmitted using the carrier aggregation in an unlicensed band, the base station apparatus can transmit signals, after performing LBT on each of the multiple carriers, or performing LBT on one carrier selected from the multiple carriers. Note that, in the case that the base station apparatus performs LBT in the one carrier selected from the multiple carriers, as for the other carriers, the base station performs the carrier sense for 25 microseconds by using the selected one carrier before transmission by using the other carriers, and can perform the transmission in a case of idle.

The terminal apparatus, according to a defined type 1 or type 2 channel access procedure for uplink, can perform uplink transmission in an unlicensed band. In the type 1 channel access procedure, the terminal apparatus performs the carrier sense for a random period of time, and in the type 2 channel access procedure, the terminal apparatus performs the carrier sense for a fixed period of time. The channel access type is indicated from the base station apparatus. A maximum period of time that the terminal apparatus can occupy is referred to as UpLink MCOT (ULMCOT). The terminal apparatus receives information indicating that other technologies do not exist from the base station apparatus via higher layer signaling. In the case of receiving information indicating that other technologies do not exist, and in a case that priority is low (for example, in cases of the priority classes 3, 4), ULMCOT is shorter than MCOT.

In a case of performing uplink transmission by using multiple carriers (cells) by the carrier aggregation in an unlicensed band, the terminal apparatus uses the channel access type 1 for one carrier randomly selected from the multiple carriers, and uses the channel access type 2 for the other carriers. Further, in a case of uplink transmission in MCOT acquired by the base station apparatus, the base station apparatus can instruct the terminal apparatus to use the channel access type 2.

Since transmittable timing may change due to LBT, the base station apparatus/terminal apparatus can start transmission by using part of a subframe. Additionally, the base station apparatus/terminal apparatus can end transmission by using part of a subframe. Note that, a subframe whose part is used for communication is also referred to as a partial subframe. Further, a subframe for starting transmission is also referred to as a start partial subframe (starting partial subframe). Further, a subframe for ending transmission is also referred to as an end partial subframe (ending partial subframe).

Additionally, in a case of communicating in an unlicensed band, the base station apparatus can assign one or multiple subframes to the terminal apparatus by using a piece of downlink control information.

The base station apparatus can start downlink transmission in units of subframes, in units of slots, or in units of mini-slots. The base station apparatus can transmit information indicating whether to start transmission in units of subframes or to start transmission in units of slots as a start position in subframes to the terminal apparatus. The terminal apparatus, in a case that the base station apparatus indicates that transmission starts in units of subframes as a start position in subframes, monitors a control channel for each subframe. Additionally, the terminal apparatus, in a case that the base station apparatus indicates that transmission starts in units of slots as a start position in subframes, monitors a control channel for each slot. Additionally, a mini-slot is a unit shorter than a slot, and for example, can be two OFDM symbols. The base station apparatus can transmit information indicating that transmission is started in units of subframes, in units of slots, or in units of mini-slots to the terminal apparatus. In a case that transmission is possibly started in units of mini-slots, the terminal apparatus monitors a control channel related to mini-slot allocation (a control signal, a control signal format). Further, the control channel related to the mini-slot allocation is allocated in an anterior part of or a posterior part of a slot.

The base station apparatus can end downlink transmission in units of OFDM symbols. The base station apparatus transmits a downlink subframe configuration in an unlicensed band by using the downlink control information/channel in common in a cell (also referred to as common downlink control information, a common downlink control channel). The downlink subframe configuration in the unlicensed band indicates the number of OFDM symbols which are occupied by signals in a next subframe or a current subframe. The base station apparatus masks a common downlink control channel with Common Cell-Radio Network Temporary Identifier (CC-RNTI) and transmits the masked common downlink control channel. C-RNTI is an identifier that the base station apparatus assigns temporarily to the terminal apparatus, and CC-RNTI is an identifier common in a cell. The terminal apparatus decodes the common downlink control channel by using CC-RNTI. Note that, the terminal apparatus decodes a downlink control channel directed to the same terminal apparatus by using C-RNTI.

In a case of communicating in an unlicensed band, a start position of PUSCH of a subframe can be included and transmitted in the downlink control information. The start position of PUSCH indicates four types, that is, a first symbol of a subframe (SC-FDMA symbol 0), timing after 25 microseconds from the first symbol, timing after 25 microseconds from the first symbol+timing advance, and a second symbol of the subframe (SC-FDMA symbol 1). Note that, the timing advance is an offset for adjusting transmission timing for the terminal apparatus. Note that, in a case that the start position of PUSCH indicates timing after 25 microseconds from the first symbol or timing after 25 microseconds from the first symbol+the timing advance, the terminal apparatus can perform transmission for a period of time between the start position and the second symbol while extending CP of the second symbol. Additionally, the base station apparatus can transmit information indicating an ending symbol of PUSCH of a subframe with the information included in the downlink control information. The information indicating the ending symbol of PUSCH indicates whether to transmit a last SC-FDMA symbol of the subframe or not. In other words, the information indicating the ending symbol of PUSCH indicates whether to transmit signals up to the last SC-FDMA symbol of the subframe or to transmit signals up to a second SC-FDMA symbol from the last SC-FDMA symbol. For example, in a case that the base station apparatus assigns one uplink subframe to the terminal apparatus, and the start position of PUSCH indicates a symbol other than the first symbol, and the ending symbol of PUSCH indicates that the signals is not transmitted in the last SC-FDMA symbol, the terminal apparatus transmits PUSCH of the subframe by using from the second SC-FDMA symbol (SC-FDMA symbol 1) to a 13th SC-FDMA symbol (SC-FDMA symbol 12). Additionally, in a case that the base station apparatus assigns multiple uplink subframes to the terminal apparatus, the information indicating the ending symbol of PUSCH indicates information of an ending symbol of a last subframe of assigned contiguous subframes.

The base station apparatus transmits the downlink control information used for scheduling of uplink (PUSCH) in an unlicensed band. The downlink control information used for scheduling one subframe and the downlink control information used for scheduling multiple subframes can have different downlink control information formats. The downlink control information used for scheduling one subframe includes some or all of a PUSCH trigger A, a timing offset, uplink resource block assignment, MCS, a PUSCH starting position, a PUSCH ending symbol, a channel access type, and a channel access priority class. The PUSCH trigger A indicates a triggered scheduling (trigger A=0) or a non-triggered scheduling (trigger A=1). The timing offset, in a case that the PUSCH trigger A indicates the non-triggered scheduling (in a case that the trigger A=0), indicates a timing offset of an absolute value of PUSCH transmission (scheduling delay). That is, the terminal apparatus transmits PUSCH by using this timing offset. Additionally, the timing offset, in a case that the PUSCH trigger A indicates the triggered scheduling (in a case that the trigger A=1), indicates a relative timing offset of PUSCH transmission and a time window (duration) for which the triggered scheduling of PUSCH is valid. The channel access type indicates the carrier sense for a random period of time (type 1), or the carrier sense for a fixed period of time (type 2). Additionally, the downlink control information used for scheduling multiple subframes includes some or all of the PUSCH trigger A, the timing offset, the resource block assignment, MCS, the PUSCH starting position, the PUSCH ending symbol, the channel access type, the channel access priority class, and the number of scheduled subframes. Note that, a maximum value of the number of scheduled subframes is transmitted from the base station apparatus to the terminal apparatus by using higher layer signaling.

In an unlicensed band, to meet a regulation for power spectrum density in a subband of a system bandwidth, uplink resource blocks are assigned in a non-contiguous manner. The uplink resource block assignment included in the downlink control information includes a start resource block, and the number of assigned resource blocks. For example, the uplink resource blocks are allocated for every 10 resource blocks. In this case, the start resource block has 10 patterns. Note that, this assignment in which the resource blocks are allocated from the start resource block at a constant interval is also referred to as an interlace allocation (interlace structure), and one or multiple interlace allocations are assigned to one terminal apparatus.

In an unlicensed band, the base station apparatus can transmit up to four pieces of downlink control information for uplink scheduling in one subframe to one terminal apparatus. Additionally, the base station apparatus, in order to reduce a computation amount for monitoring the downlink control channel of the terminal apparatus, can transmit information indicating whether to request monitoring for each downlink control information format or not. At this time, the terminal apparatus, according to indication from the base station apparatus, does not monitor a downlink control information format for which monitoring is not requested.

The base station apparatus can transmit information indicating an uplink transmission period and an uplink offset, and a PUSCH trigger B with the information included in the common downlink control information. The information indicating the uplink transmission period and the uplink offset indicates an uplink offset and an uplink period. In a case that the terminal apparatus detects the common downlink control information in a subframe n, the terminal apparatus need not receive a downlink physical channel/physical signal in a subframe n+d+i (i=0, 1, . . . e−1), where the uplink offset is d, and the uplink period is e.

The terminal apparatus, in a case that a value of the trigger A included in the downlink control information of the subframe n is 0, or in a case that the value of the trigger A included in the downlink control information closest to a subframe n−v is 1 and a value of the trigger B included in the common downlink control information of the subframe n is 1, transmits PUSCH in a subframe n+d+k+i. i ranges from 0 to N−1, and N denotes the number of scheduled contiguous subframes. In a case that the trigger A=0, k is obtained by the timing offset included in the downlink control information. In a case that the trigger A=1, by the timing offset included in the downlink control information, k is obtained from a relative timing offset, and v is obtained from a scheduling validity period. Additionally, in a case that the trigger A=0, a relation of d=4 holds. In a case that the trigger A=1, d is an uplink offset obtained from the common downlink control information. Additionally, a minimum value of d+k indicates terminal capability.

The terminal apparatus, in the case that the uplink offset d and the uplink period e are obtained from the common downlink control information in the subframe n, and transmission to the terminal apparatus ends in a subframe n+d+e−1 or earlier, can perform uplink transmission using the channel access type 2. Additionally, the terminal apparatus, in a case that multiple subframes are scheduled with a piece of downlink control information, and in a case that the carrier sense fails in a subframe other than a last subframe, tries to perform transmission in a next subframe.

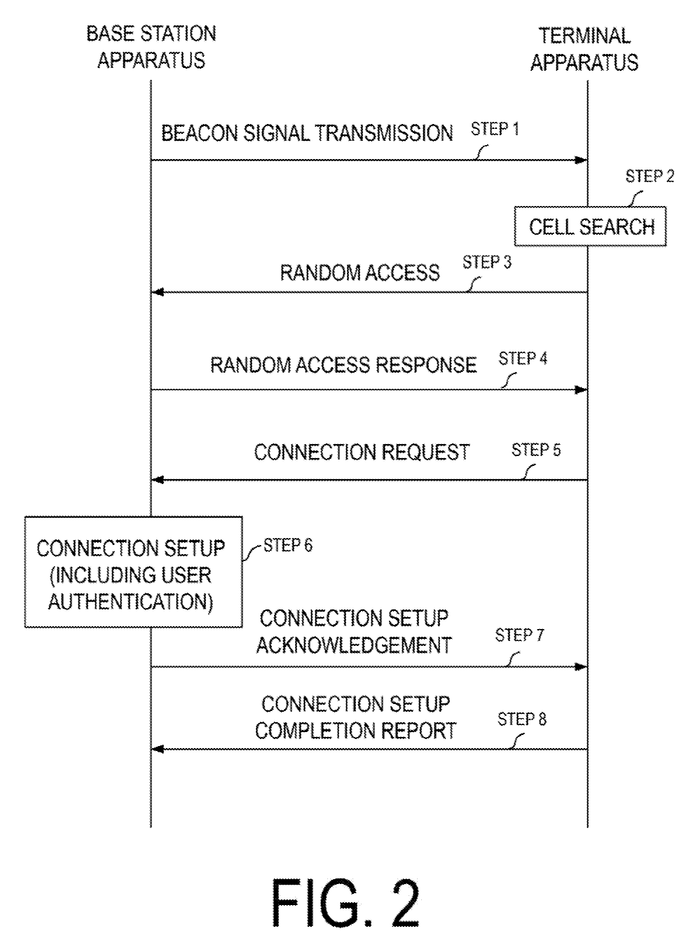

In ULSA, the terminal apparatus needs cell search for probing the base station apparatus in an unlicensed band. FIG. 2 illustrates, in a simplified manner, as an example, a procedure for the terminal apparatus to connect with the base station apparatus. First, the base station apparatus periodically transmits a signal with which a cell ID can be identified, system information, and the like (step 1). Note that, the signal with which a cell ID can be identified, the system information, and the like periodically transmitted from the base station apparatus are also collectively referred to as a beacon signal. The terminal apparatus performs the cell search, acquires a cell ID of a cell with which the terminal apparatus wants to connect because the cell has suitable communication quality, a desirable service or function, or the like, and receives system information (step 2). The terminal apparatus transmits a random access channel (random access preamble) to the cell with which the terminal apparatus wants to connect (step 3). The base station apparatus, in a case of receiving the random access channel from the terminal apparatus, transmits a random access response to that terminal apparatus (step 4). The terminal apparatus requests connection to the base station apparatus (step 5). The terminal apparatus, in a case of requesting connection, includes a random ID of the terminal apparatus, information required for user authentication, or the like in the request. The base station apparatus performs connection setup (step 6). At this time, the user authentication for the terminal apparatus requesting the connection is performed, and an encryption key or the like is issued. After the user authentication is performed and the connection is set up, the base station apparatus transmits a message acknowledging the connection setup to the terminal apparatus (step 7). The terminal apparatus, after the connection setup is completed, reports the completion to the base station apparatus (step 8).

A beacon signal includes, for example, a synchronization signal, a discovery signal, system information, a cycle of the beacon signal, or the like. As the synchronization signal, a Primary Synchronization Signal (PSS) and a Secondary Synchronization Signal (SSS) exist. Additionally, the discovery signal includes some or all of CRS, the synchronization signal, and CSI-RS. Since ULSA needs LBT before transmission, it is desirable to transmit signals in a short period of time or in a small number of times of transmissions, and the terminal apparatus desirably performs the cell search. Thus, in a case that a beacon signal includes a synchronization signal/discovery signal, density of the synchronization signal transmitted by ULSA is higher than density of the synchronization signal transmitted in a licensed band or by LAA. For example, a bandwidth of the synchronization signal in ULSA is wider than that of the synchronization signal in a licensed band/LAA. Additionally, for example, time density (the number of OFDM symbols transmitted in one subframe or the like) of the synchronization signal in ULSA is higher than time density of the synchronization signal in the licensed band/LAA. Further, in order to improve communication efficiency, a beacon signal can include PDSCH. Additionally, the base station apparatus, in a case of failing in the carrier sense at timing of transmitting a beacon signal (case of not success), can skip or delay transmitting that beacon signal. Note that, maximum delay time in the case of delaying transmission can be defined in specifications in advance.

Note that, the base station apparatus can perform operation with respect to the timing at which the beacon signal is transmitted. For example, the base station apparatus, from the timing at which the beacon signal is transmitted, only for a predetermined period of time, can perform ULSA, that is, can transmit a downlink signal and receive an uplink signal in an unlicensed band. By being controlled in this way, the base station apparatus and the terminal apparatus are to operate only for the predetermined period of time, so power consumption can be reduced. This means that, the beacon signal serves as a Wake-up signal for the terminal apparatus.

Additionally, the base station apparatus can transmit the beacon signal as a signal for securing MCOT in order for the same base station apparatus to perform communication (broadcast/groupcast, or communication with the terminal apparatus that has already been completed a connection process with the same base station apparatus is included). Note that, the base station apparatus and the terminal apparatus can perform ULSA even after lapse of the predetermined period of time. That is, the base station apparatus can divide a time section between the beacon signals to be periodically transmitted into a scheduling period in which ULSA is always performed, and an unscheduling period in which ULSA is not always necessarily performed. A length of the scheduling period (i.e., the predetermined period of time), a length of the unscheduling period, and information indicating whether the unscheduling period exists or not can be included in the beacon signal.

Note that, the terminal apparatus, in the scheduling period, can be controlled so as not to perform communication for the connection process with the base station apparatus. That is, for the terminal apparatus according to the present embodiment, a radio a resource with which communication for the connection process with the base station apparatus can be performed can be controlled by the base station apparatus. By control in this way, the base station apparatus can use an unlicensed band that the same base station apparatus secures, preferentially for actual data communication rather than communication for controlling. Additionally, the base station apparatus, can inform the terminal apparatus of information indicating whether the unscheduling period exists in a downlink control signal to be transmitted in the scheduling period or not. Additionally, the base station apparatus can include information indicating whether to divide into the scheduling period in which ULSA is always performed, and the unscheduling period in which ULSA is not always necessarily performed, in a beacon signal, or in a downlink control signal.

The terminal apparatus, can assume that a beacon signal is to be transmitted from the base station apparatus with a delay from a previously informed timing, and stay in a receiving state from the previously informed timing, for the predetermined period of time. However, in a case that even after a lapse of the predetermined period of time from the previously informed timing, and a beacon frame is not transmitted from the base station apparatus, the terminal apparatus need not maintain the receiving state. The predetermined period of time can be defined in advance between the base station apparatus and the terminal apparatus, or the base station apparatus can signal to the terminal apparatus by using a beacon signal or control information transmitted in the downlink.

Note that, the base station apparatus, can include a reference signal (pilot signal) known between the base station apparatus and the terminal apparatus in a beacon signal. The base station apparatus can include a plurality of the pilot signals in a beacon signal. The terminal apparatus receiving a beacon signal including the pilot signal, by using the pilot signal, can perform beam scanning (beam sweep) for controlling a beam pattern of an antenna that the same terminal apparatus includes. The terminal apparatus can perform the beam sweep by using PSS, SSS, or a discovery signal included in the beacon signal. Additionally, the base station apparatus can transmit a plurality of the beacon signals by using different beam patterns. The base station apparatus can include information indicating a used beam pattern (a beam identifier, a beam pattern identifier, transmission timing (time), a transmission frequency) in a beacon signal. The terminal apparatus can include information indicating a beam pattern used for a beacon signal suited for the same terminal apparatus in an uplink signal (random access preamble or the like) described later.

Further, by transmission from the terminal apparatus, the terminal apparatus can also probe the base station apparatus. For example, the terminal apparatus, in a case of being unable to detect a beacon signal, transmits a probe request, to request the base station apparatus to transmit a beacon signal. The base station apparatus, in a case of receiving the probe request, transmits or broadcasts a probe response (or a beacon signal) addressed to the terminal apparatus. Subsequent processing is identical to the procedure explained using FIG. 2. The probe request transmitted by the terminal apparatus includes an uplink preamble signal and terminal (user) information (data). The uplink preamble signal includes an uplink reference signal (e.g., SRS) and/or an uplink synchronization signal. Additionally, the terminal information includes ID and/or a service/function that the terminal apparatus requests. The uplink synchronization signal is generated based on a common ID or a terminal-specific ID. The common ID may be defined in specifications. The terminal apparatus transmits the probe request at arbitrary timing, so the base station apparatus receives the uplink synchronization signal, detects the timing, and reads the terminal information. In a case that the terminal information includes the service/function requested by the terminal apparatus, the base station apparatus, in a case of being able to provide the service/function requested by the terminal apparatus, transmits a probe response (or a beacon signal). In a case of being unable to provide the service/function requested by the terminal apparatus, the base station apparatus need not transmit a probe response (or a beacon signal).

Note that, in a case that an unlicensed band is divided into multiple frequency bands (frequency channels) (e.g., a case that an unlicensed band is divided into multiple 20 MHz channels), a frequency channel on which the terminal apparatus transmits a probe request can be limited to (a single or multiple) predetermined frequency channels. Note that, the base station apparatus may transmit a beacon signal caused by the probe request on an identical frequency channel to the frequency channel in which the probe request causing the beacon signal has been transmitted, but can transmit the beacon signal on a different frequency channel. Further, similarly to the probe request, a channel on which the base station apparatus transmits a beacon signal can be limited to (a single or multiple) predetermined frequency channels. By being controlled in this way, the base station apparatus and the terminal apparatus according to the present embodiment can avoid an unlicensed band being occupied by signals for controlling. Note that, in a case that a probe signal is transmitted on a predetermined frequency channel, in a case that the terminal apparatus recognizes that another terminal apparatus is transmitting a probe signal, the same terminal apparatus can stop transmitting a probe signal to transit to a receiving operation for receiving a beacon signal caused by the probe signal transmitted by the other terminal apparatus.

Additionally, a random access preamble is configured with CP and a sequence. A CP length and a sequence length are specified in a preamble format. Additionally, the base station apparatus can specify a preamble format, a system frame number, a subframe number, and an RACH route sequence in a PRACH configuration index. The PRACH configuration index is transmitted in a higher layer signal (system information). The system frame number is a radio frame number, and the subframe number is a subframe number (index) in the radio frame. Further, an RACH sequence is generated based on the RACH route sequence. The terminal apparatus, based on information specified by the base station apparatus, generates a random access preamble, and transmits the random access preamble with a specified frequency/time resource. Additionally, the terminal apparatus, in order to meet regulations in each country, transmits the random access preamble by using different signal mapping between a licensed band and an unlicensed band. In a licensed band, the terminal apparatus transmits a random access preamble by using contiguous resource blocks. In an unlicensed band, the terminal apparatus transmits a random access preamble by using non-contiguous (allocated in an interlace manner) resource blocks. The base station apparatus can include information indicating the interlace allocation of PRACH, in system information or common downlink control information. The information indicating the interlace allocation of PRACH is, for example, information indicating a starting resource block in the interlace allocation. At this time, the terminal apparatus, can transmit a random access preamble with a system frame number, a subframe number, and a resource block allocation specified by the base station apparatus.

ULSA lacks assistance from a licensed band, so there is a high possibility that, due to influence of LBT, timing at which communication can be started shifts for each base station apparatus/terminal apparatus. Thus, which communication apparatus has transmitted can desirably be identified at the start of transmission. As an example, transmitting a preamble signal being a signal known on a transmitting side and a receiving side such as a synchronization signal or a reference signal at the start of the communication is conceivable. For example, the base station apparatus can determine not to transmit a terminal apparatus specific signal/channel (e.g., PDSCH, PDCCH) in first some symbols to be transmitted in MCOT. Note that, hereinafter, the first some symbols to be transmitted in MCOT are also collectively referred to as, a preamble signal, a preamble period (section), or an initial signal. The preamble signal/period may be part of a subframe, or may not be part of a subframe. In a case that a preamble signal is part of a subframe, the preamble signal is transmitted in some subframes (e.g., a leading subframe) in contiguous subframes to be transmitted in MCOT. Additionally, in a case that a preamble signal is not part of a subframe, contiguous subframes are transmitted after the preamble signal in MCOT. For example, in a preamble signal, CRS/a synchronization signal is transmitted. Additionally, a common downlink control channel can be transmitted in a preamble signal/period. Accordingly, the terminal apparatus can recognize (identify) which cell has transmitted. Further, the base station apparatus can transmit the number of preamble signals, or a preamble period, or a starting position of PDSCH/PDCCH to the terminal apparatus. A starting symbol of PDSCH/PDCCH can be transmitted in advance with system information, RRC signalling, or a common downlink control channel. Note that, in a case that the base station apparatus schedules the uplink, a preamble signal of the uplink is not necessary.

In an unlicensed band, the terminal apparatus can transmit uplink control information. The uplink control information is transmitted on PUSCH or PUCCH. The uplink control information includes some or all of HARQ ACK/NACK, and CSI. Since PUCCH includes a small amount of information, the terminal apparatus can transmit PUCCH in a mini-slot. In a case that PUCCH is transmitted in an unlicensed band, since regulations in each country need to be met, the terminal apparatus transmits PUCCH with an interlace allocation. Thus, in a licensed band, PUCCH is allocated in two slots, but in the unlicensed band, PUCCH is allocated in one slot. Note that, the terminal apparatus can multiplex and transmit PUCCH and PUSCH by using different interlace allocations.

For an unlicensed band, a license is not required, so it is preferable that each communication apparatus be able to acquire an equal communication opportunity. The communication opportunity relates to a maximum energy detection threshold value during the carrier sense. For example, in a case that a wireless LAN and LAA coexist (a case that another technology exists), since LAA is assisted by the base station apparatus in a licensed band, a maximum energy detection threshold value of LAA is larger than a maximum energy detection threshold value of the wireless LAN. On the other hand, ULSA lacks assistance from a licensed band, so in the case that a wireless LAN and ULSA coexist (the case that another technology exists), the respective maximum energy detection threshold values of the wireless LAN and ULSA are equivalent. That is, in a case that the base station apparatus transmits information indicating that another technology exists, the maximum energy detection threshold value of ULSA is smaller than the maximum energy detection threshold value of LAA. Note that, in a case that the base station apparatus transmits information indicating that another technology does not exist, the respective maximum energy detection threshold values of ULSA and LAA can be equivalent.

Note that, in ULSA, in a case that the base station apparatus or the terminal apparatus transmits a signal including the above-described preamble, another base station apparatus or terminal apparatus, in a case of receiving the signal including the preamble, can recognize that the signal is a signal transmitted by ULSA (ULSA signal). For each of the base station apparatus and the terminal apparatus according to the present embodiment, different values can be set for threshold values at the time of the carrier sense, between in a case of being capable of recognizing that a received signal is a ULSA signal, and in a case of being capable of recognizing that a signal is different from a ULSA signal (non ULSA signal). For example, in a case that a signal that the base station apparatus or the terminal apparatus receives can be recognized as a ULSA signal, a higher threshold value at the time of the carrier sense can be set than that in a case that the signal can be recognized as a non ULSA signal. This is because the base station apparatus and the terminal apparatus according to the present embodiment can recognize a signal configuration, a communication method, or the like of a ULSA signal, and even in a case that ULSA signals collide with each other, there is a possibility that each of the ULSA signals can be demodulated correctly. For example, in the case that a signal that the base station apparatus or the terminal apparatus receives can be recognized as a ULSA signal, a lower threshold value at the time of the carrier sense can be set than that in the case that the signal can be recognized as a non ULSA signal. By being controlled in this way, interference power for a ULSA signal is reduced, so reception quality can be improved.

By applying a mobile communication method to a licensed band and a licensed band, the base station apparatus and/or the terminal apparatus can communicate in three configurations, that is, communication only in a licensed band (LA), communication in a licensed band and an unlicensed band (LAA), and communication only in an unlicensed band (ULSA). Additionally, in a case that these three configurations can be efficiently changed, it is possible to support various demands or use cases. For example, since in LA and LAA, communication in a common licensed band is performed, the configurations can be efficiently changed in a configuration of the carrier aggregation/dual connectivity. Additionally, for example, shifting from ULSA to LA or LAA, or shifting from LA or LAA to ULSA can be performed by handover. That is, the terminal apparatus, can hand over from a cell in an unlicensed band to a cell in a licensed band, and can also hand over from a cell in a licensed band to a cell in an unlicensed band. Additionally, in a case of ULSA, the terminal apparatus can also hand over from a cell in an unlicensed band to a cell in an unlicensed band. For example, the terminal apparatus communicating by ULSA, measures RSRP/RSRQ in cells in a licensed band and in a licensed band, and reports RSRP/RSRQ to the base station apparatus (PCell). The base station apparatus, in a case that RSRP/RSRQ falls below a predetermined threshold value in a cell in an unlicensed band, instructs the terminal apparatus to hand over to a cell in a licensed band. Note that, in a case of performing the carrier aggregation in ULSA, and PCell in an unlicensed band hands over to PCell in a licensed band, the base station apparatus/terminal apparatus can communicate by LAA. Further, in a case of handover from LA or LAA to ULSA, management may be performed in a licensed band in an RRC idle state.

Note that, the base station apparatus, in MCOT that the same base station apparatus has acquired, can allow (instruct, trigger) the terminal apparatus connected with the same base station apparatus to transmit a signal. The base station apparatus according to the present embodiment can, in an MCOT period secured by ULSA (MCOT secured by transmission of a ULSA signal), allow the terminal apparatus to communicate only by ULSA. Additionally, the base station apparatus according to the present embodiment, in an MCOT period secured by ULSA (or LAA), can trigger communication by LAA (or ULSA) for the terminal apparatus. That is, in MCOT secured by the base station apparatus according to the present embodiment, a case that only a signal transmitted by ULSA is included, and a case that signals transmitted by ULSA or LAA are mixed (multiplexed) can be allowed.

Note that, in a case that a maximum energy detection threshold value of ULSA (or LAA) is larger than a maximum energy detection threshold value of LAA (or MCOT), the base station apparatus can mix (multiplex) signals in ULSA and LAA in MCOT secured by the carrier sense using an energy detection threshold value adjusted to LAA (or ULSA). Additionally, in the case that the maximum energy detection threshold value of ULSA (or LAA) is larger than the maximum energy detection threshold value of LAA (or MCOT), transmission by LAA (or ULSA) cannot be performed in MCOT that the base station apparatus has secured by the carrier sense using the maximum energy detection threshold value of ULSA (or LAA). Conversely, in a case that the maximum energy detection threshold value of ULSA (or LAA) is smaller than the maximum energy detection threshold value of LAA (or MCOT), the base station apparatus can mix (multiplex) signals in ULSA and LAA in MCOT secured by the carrier sense for ULSA (or LAA).

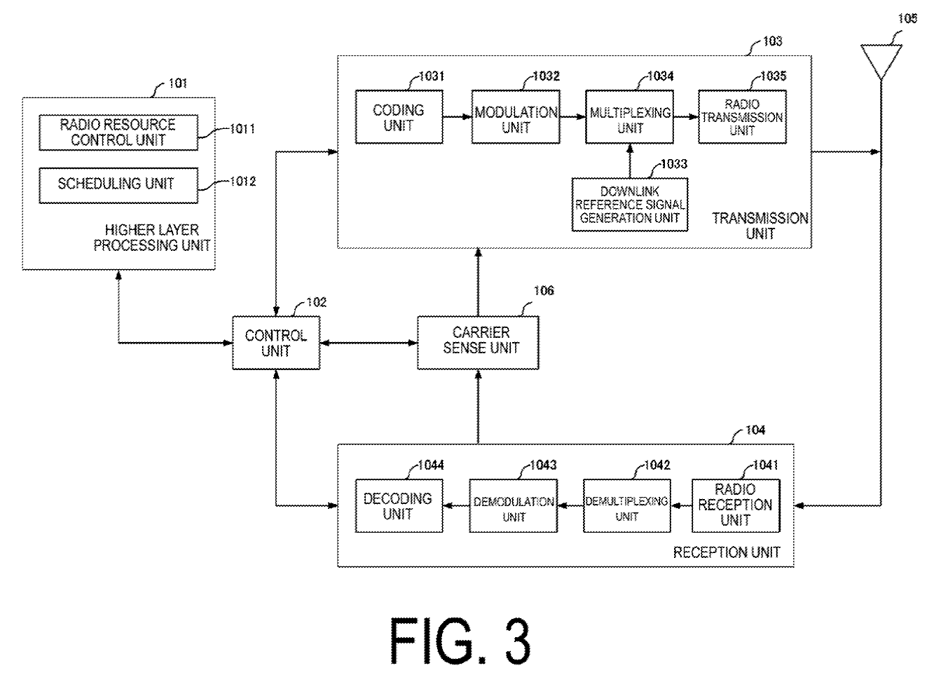

FIG. 3 is a schematic block diagram illustrating a configuration of the base station apparatus 1A according to the present embodiment. As illustrated in FIG. 7, the base station apparatus 1A is configured, including a higher layer processing unit (higher layer processing step) 101, a control unit (controlling step) 102, a transmission unit (transmitting step) 103, a reception unit (receiving step) 104, a transmit and/or receive antenna 105, and a carrier sense unit (carrier sense step) 106. The higher layer processing unit 101 is configured, including a radio resource control unit (radio resource controlling step) 1011 and a scheduling unit (scheduling step) 1012. The transmission unit 103 is configured, including a coding unit (coding step) 1031, a modulation unit (modulating step) 1032, a downlink reference signal generation unit (downlink reference signal generating step) 1033, a multiplexing unit (multiplexing step) 1034, and a radio transmission unit (radio transmitting step) 1035. The reception unit 104 is configured, including a radio reception unit (radio receiving step) 1041, a demultiplexing unit (demultiplexing step) 1042, a demodulation unit (demodulating step) 1043, and a decoding unit (decoding step) 1044.

The higher layer processing unit 101 performs processing of the Medium Access Control (MAC) layer, the Packet Data Convergence Protocol (PDCP) layer, the Radio Link Control (RLC) layer, and the Radio Resource Control (RRC) layer. Furthermore, the higher layer processing unit 101 generates information necessary for control of the transmission unit 103 and the reception unit 104, and outputs the generated information to the control unit 102.

The higher layer processing unit 101 receives information of a terminal apparatus, such as UE capability or the like, from the terminal apparatus. To rephrase, the terminal apparatus transmits its function to the base station apparatus by higher layer signaling.

Note that in the following description, information of a terminal apparatus includes information indicating whether the stated terminal apparatus supports a predetermined function, or information indicating that the stated terminal apparatus has completed the introduction and test of a predetermined function. In the following description, information of whether the predetermined function is supported includes information of whether the introduction and test of the predetermined function have been completed.

For example, in a case where a terminal apparatus supports a predetermined function, the stated terminal apparatus transmits information (parameters) indicating whether the predetermined function is supported. In a case where a terminal apparatus does not support a predetermined function, the stated terminal apparatus does not transmit information (parameters) indicating whether the predetermined function is supported. In other words, whether the predetermined function is supported is reported by whether information (parameters) indicating whether the predetermined function is supported is transmitted. Information (parameters) indicating whether a predetermined function is supported may be reported using one bit of 1 or 0.

The radio resource control unit 1011 generates, or acquires from a higher node, downlink data (a transport block) allocated in the downlink PDSCH, system information, an RRC message, a MAC Control Element (CE), and the like. The radio resource control unit 1011 outputs the downlink data to the transmission unit 103, and outputs other information to the control unit 102. Furthermore, the radio resource control unit 1011 manages various configuration information of the terminal apparatuses.

The scheduling unit 1012 determines a frequency and a subframe to which the physical channels (PDSCH and PUSCH) are allocated, a coding rate and modulation scheme (or MCS) for the physical channels (PDSCH and PUSCH), transmit power, and the like. The scheduling unit 1012 outputs the determined information to the control unit 102.

The scheduling unit 1012 generates information to be used for scheduling of the physical channels (PDSCH and PUSCH), based on a result of the scheduling. The scheduling unit 1012 outputs the generated information to the control unit 102.

Based on information input from the higher layer processing unit 101, the control unit 102 generates a control signal for controlling of the transmission unit 103 and the reception unit 104. The control unit 102 generates the downlink control information based on the information input from the higher layer processing unit 101, and outputs the generated information to the transmission unit 103. Additionally, the control unit 102, in a case of communicating in an unlicensed band, based on the information input from the higher layer processing unit 101, controls the carrier sense unit 106 to perform the carrier sense and secures channel occupancy time. Additionally, the control unit 102, after success in the carrier sense, controls the transmission unit 103 to transmit a resource securing signal, a transmit signal, or the like.

The transmission unit 103 generates the downlink reference signal in accordance with the control signal input from the control unit 102, codes and modulates the HARQ indicator, the downlink control information, and the downlink data that are input from the higher layer processing unit 101, multiplexes PHICH, PDCCH, EPDCCH, PDSCH, and the downlink reference signal, and transmits a signal obtained through the multiplexing to the terminal apparatus 2 through the transmit and/or receive antenna 105.

The coding unit 1031 codes the HARQ indicator, the downlink control information, and the downlink data that are input from the higher layer processing unit 101, in compliance with the coding scheme prescribed in advance, such as block coding, convolutional coding, or turbo coding, or in compliance with the coding scheme determined by the radio resource control unit 1011. The modulation unit 1032 modulates the coded bits input from the coding unit 1031, in compliance with the modulation scheme prescribed in advance, such as Binary Phase Shift Keying (BPSK), Quadrature Phase Shift Keying (QPSK), Quadrature Amplitude Modulation (16QAM), 64QAM, or 256QAM, or in compliance with the modulation scheme determined by the radio resource control unit 1011.

The downlink reference signal generation unit 1033 generates, as the downlink reference signal, a sequence that has been known to the terminal apparatus 2A and that is acquired in accordance with a rule prescribed in advance based on the Physical Cell Identity (PCI, cell. ID) for identifying the base station apparatus 1A, and the like.

The multiplexing unit 1034 multiplexes the modulated modulation symbol of each channel, the generated downlink reference signal, and the downlink control information. To be more specific, the multiplexing unit 1034 maps the modulated modulation symbol of each channel, the generated downlink reference signal, and the downlink control information to resource elements.

The radio transmission unit 1035 performs Inverse Fast Fourier Transform (IFFT) on the modulation symbol resulting from the multiplexing or the like to generate an OFDM symbol, attaches a Cyclic Prefix (CP) to the generated OFDM symbol to generate a baseband digital signal, converts the baseband digital signal into an analog signal, removes unnecessary frequency components through filtering, up-converts a result of the removal into a signal of a carrier frequency, performs power amplification, and outputs a final result to the transmit and/or receive antenna 105 for transmission.

In accordance with the control signal input from the control unit 102, the reception unit 104 demultiplexes, demodulates, and decodes the reception signal received from the terminal apparatus 2A through the transmit and/or receive antenna 105, and outputs information resulting from the decoding to the higher layer processing unit 101.

The radio reception unit 1041 converts, by down-converting, an uplink signal received through the transmit and/or receive antenna 105 into a baseband signal, removes unnecessary frequency components, controls the amplification level in such a manner as to suitably maintain a signal level, performs orthogonal demodulation based on an in-phase component and an orthogonal component of the received signal, and converts the resulting orthogonally-demodulated analog signal into a digital signal.

The radio reception unit 1041 removes a portion corresponding to CP from the digital signal resulting from the conversion. The radio reception unit 1041 performs Fast Fourier Transform (FFT) on the signal from which CP has been removed, extracts a signal in the frequency domain, and outputs the resulting signal to the demultiplexing unit 1042.

The demultiplexing unit 1042 demultiplexes the signal input from the radio reception unit 1041 into PUCCH, PUSCH, and the signal such as the uplink reference signal. The demultiplexing is performed based on radio resource allocation information that is determined in advance by the base station apparatus 1A using the radio resource control unit 1011 and that is included in the uplink grant notified to each of the terminal apparatuses 2.

Furthermore, the demultiplexing unit 1042 makes a compensation of channels including PUCCH and PUSCH. The demultiplexing unit 1042 demultiplexes the uplink reference signal.

The demodulation unit 1043 performs Inverse Discrete Fourier Transform (IDFT) on PUSCH, acquires modulation symbols, and performs reception signal demodulation, that is, demodulates each of the modulation symbols of PUCCH and PUSCH, in compliance with the modulation scheme prescribed in advance, such as BPSK, QPSK, 16QAM, 64QAM, 256QAM, or the like, or in compliance with the modulation scheme that the base station apparatus 1A itself has notified in advance, with the uplink grant, each of the terminal apparatuses 2.

The decoding unit 1044 decodes the coded bits of PUCCH and PUSCH, which have been demodulated, at the coding rate in compliance with a coding scheme prescribed in advance, the coding rate being prescribed in advance or being notified in advance with the uplink grant to the terminal apparatus 2 by the base station apparatus 1A itself, and outputs the decoded uplink data and uplink control information to the higher layer processing unit 101. In a case where PUSCH is re-transmitted, the decoding unit 1044 performs the decoding with the coded bits input from the higher layer processing unit 101 and retained in an HARQ buffer, and the demodulated coded bits.

The carrier sense unit 106, according to a channel priority class, a channel access type, or the like, performs the carrier sense, and secures channel occupancy time.

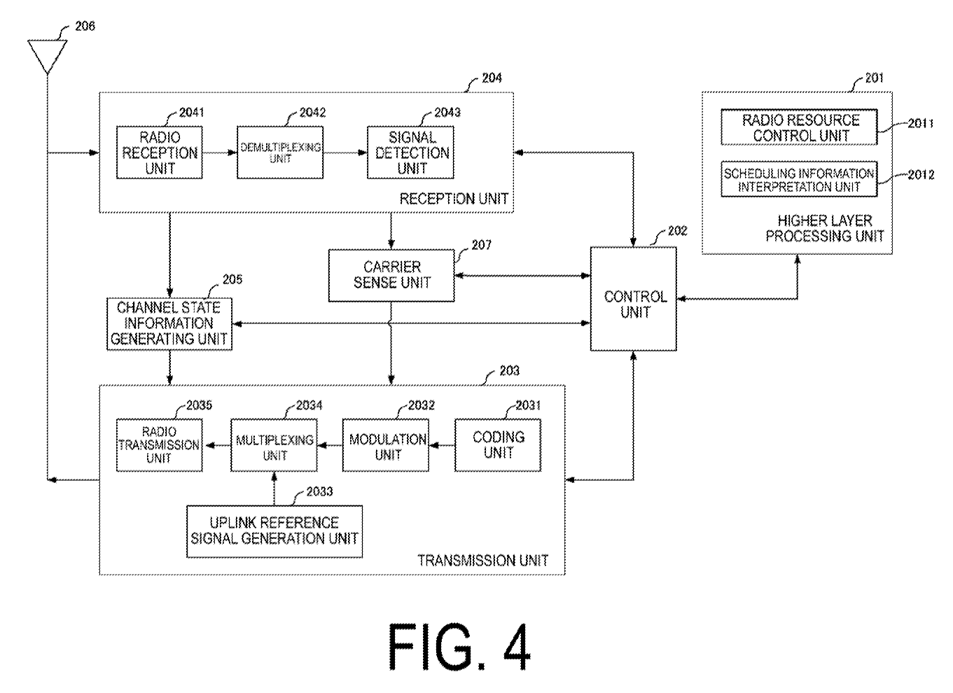

FIG. 4 is a schematic block diagram illustrating a configuration of the terminal apparatus 2 according to the present embodiment. As illustrated in FIG. 7, the terminal apparatus 2A is configured, including a higher layer processing unit (higher layer processing step) 201, a control unit (controlling step) 202, a transmission unit (transmitting step) 203, a reception unit (receiving step) 204, a channel state information generating unit (channel state information generating step) 205, a transmit and/or receive antenna 206, and a carrier sense unit (carrier sense step) 207. The higher layer processing unit 201 is configured, including a radio resource control unit (radio resource controlling step) 2011 and a scheduling information interpretation unit (scheduling information interpreting step) 2012. The transmission unit 203 is configured, including a coding unit (coding step) 2031, a modulation unit (modulating step) 2032, an uplink reference signal generation unit (uplink reference signal generating step) 2033, a multiplexing unit (multiplexing step) 2034, and a radio transmission unit (radio transmitting step) 2035. The reception unit 204 is configured, including a radio reception unit (radio receiving step) 2041, a demultiplexing unit (demultiplexing step) 2042, and a signal detection unit (signal detecting step) 2043.

The higher layer processing unit 201 outputs uplink data (a transport block) generated by a user operation or the like, to the transmission unit 203. The higher layer processing unit 201 performs processing of the Medium Access Control (MAC) layer, the Packet Data Convergence Protocol (PDCP) layer, the Radio Link Control (RLC) layer, and the Radio Resource Control (RRC) layer.

The higher layer processing unit 201 outputs, to the transmission unit 203, information indicating a terminal apparatus function supported by the terminal apparatus 2A itself.

Furthermore, the radio resource control unit 2011 manages various pieces of configuration information of the terminal apparatus 2A itself. Furthermore, the radio resource control unit 2011 generates information to be mapped to each uplink channel, and outputs the generated information to the transmission unit 203.

The radio resource control unit 2011 acquires configuration information of CSI feedback transmitted from the base station apparatus, and outputs the acquired information to the control unit 202.

The radio resource control unit 2011 acquires information for the carrier sense in an unlicensed band, which has been transmitted from the base station apparatus, and outputs the acquired information to the control unit 202.

The scheduling information interpretation unit 2012 interprets the downlink control information received through the reception unit 204, and determines scheduling information. The scheduling information interpretation unit 2012 generates the control information in order to control the reception unit 204 and the transmission unit 203 in accordance with the scheduling information, and outputs the generated information to the control unit 202.

Based on the information input from the higher layer processing unit 201, the control unit 202 generates a control signal for controlling the reception unit 204, the channel state information generating unit 205, and the transmission unit 203. The control unit 202 outputs the generated control signal to the reception unit 204, the channel state information generating unit 205, and the transmission unit 203 to control the reception unit 204 and the transmission unit 203.

The control unit 202 controls the transmission unit 203 to transmit CSI generated by the channel state information generating unit 205 to the base station apparatus.

The control unit 202, in a case of communicating in an unlicensed band, in order to secure channel occupancy time, controls the carrier sense unit 207. Additionally, the control unit 202 calculates an energy detection threshold value from transmit power, a bandwidth, or the like, and outputs the calculated energy detection threshold value to the carrier sense unit 207.

In accordance with the control signal input from the control unit 202, the reception unit 204 demultiplexes, demodulates, and decodes a reception signal received from the base station apparatus 1A through the transmit and/or receive antenna 206, and outputs the resulting information to the higher layer processing unit 201.

The radio reception unit 2041 converts, by down-converting, a downlink signal received through the transmit and/or receive antenna 206 into a baseband signal, removes unnecessary frequency components, controls an amplification level in such a manner as to suitably maintain a signal level, performs orthogonal demodulation based on an in-phase component and an orthogonal component of the received signal, and converts the resulting orthogonally-demodulated analog signal into a digital signal.

The radio reception unit 2041 removes a portion corresponding to CP from the digital signal resulting from the conversion, performs fast Fourier transform on the signal from which CP has been removed, and extracts a signal in the frequency domain.

The demultiplexing unit 2042 demultiplexes the extracted signal into PHICH, PDCCH, EPDCCH, PDSCH, and the downlink reference signal. Further, the demultiplexing unit 2042 makes a compensation of channels including PHICH, PDCCH, and EPDCCH based on a channel estimation value of the desired signal obtained from the channel measurement, detects the downlink control information, and outputs the information to the control unit 202. The control unit 202 outputs PDSCH and the channel estimation value of the desired signal to the signal detection unit 2043.

The signal detection unit 2043, using PDSCH and the channel estimation value, detects a signal, and outputs the detected signal to the higher layer processing unit 201.

The transmission unit 203 generates the uplink reference signal in accordance with the control signal input from the control unit 202, codes and modulates the uplink data (the transport block) input from the higher layer processing unit 201, multiplexes PUCCH, PUSCH, and the generated uplink reference signal, and transmits a result of the multiplexing to the base station apparatus 1A through the transmit and/or receive antenna 206.

The coding unit 2031 codes the uplink control information input from the higher layer processing unit 201 in compliance with a coding scheme, such as convolutional coding or block coding. Furthermore, the coding unit 2031 performs turbo coding in accordance with information used for the scheduling of PUSCH.

The modulation unit 2032 modulates coded bits input from the coding unit 2031, in compliance with the modulation scheme notified with the downlink control information, such as BPSK, QPSK, 16QAM, or 64QAM, or in compliance with a modulation scheme prescribed in advance for each channel.

The uplink reference signal generation unit 2033 generates a sequence acquired according to a rule (formula) prescribed in advance, based on a Physical Cell Identity (PCI, also referred to as a cell ID or the like) for identifying the base station apparatus 1A, a bandwidth to which the uplink reference signal is mapped, a cyclic shift notified with the uplink grant, a parameter value for generation of a DMRS sequence, and the like.

In accordance with the control signal input from the control unit 202, the multiplexing unit 2034 reallocates modulation symbols of PUSCH in parallel and then performs Discrete Fourier Transform (DFT) on the reallocated modulation symbols. Furthermore, the multiplexing unit 2034 multiplexes PUCCH and PUSCH signals and the generated uplink reference signal for each transmit antenna port. To be more specific, the multiplexing unit 2034 maps the PUCCH and PUSCH signals and the generated uplink reference signal to the resource elements for each transmit antenna port.

The radio transmission unit 2035 performs Inverse Fast Fourier Transform (IFFT) on a signal resulting from the multiplexing, performs the modulation of SC-FDMA scheme, generates an SC-FDMA symbol, attaches CP to the generated SC-FDMA symbol, generates a baseband digital signal, converts the baseband digital signal into an analog signal, removes unnecessary frequency components, up-converts a result of the removal into a signal of a carrier frequency, performs power amplification, and outputs a final result to the transmit and/or receive antenna 206 for transmission.

The carrier sense unit 207, by using a channel priority class, a channel access type, an energy detection threshold value, and the like, performs the carrier sense, and secures channel occupancy time.

Note that, the terminal apparatus 2 can modulate, not only using an SC-FDMA scheme, but also using an OFDMA scheme.

Note that, a frequency band used by the apparatuses (base station apparatus, terminal apparatus) according to the present embodiment, is not limited to the licensed band or the unlicensed band described thus far. Frequency bands to which the present embodiment applies include a frequency band referred to as a white band (white space) for which a license for specific services is given from a country or a region but is not actually used because of preventing interference among frequencies (for example, a frequency band assigned for telecasting but unused depending on regions), a shared frequency band that is exclusively assigned to a specific operator thus far, but is expected to be shared among multiple operators in the future (a license sharing band), or the like.

A program running on an apparatus according to the present invention may serve as a program that controls a Central Processing Unit (CPU) and the like to cause a computer to operate in such a manner as to enable the functions of the embodiment according to the present invention. Programs or the information handled by the programs are temporarily stored in a volatile memory, such as a Random Access Memory (RAM), a non-volatile memory, such as a flash memory, a Hard Disk Drive (HDD), or other storage device systems.

Note that, a program for enabling functions of the embodiments according to the present invention may be recorded on a computer-readable recording medium. By causing a computer system to read the program recorded on the recording medium for execution, the functions of the embodiments according to the present invention may be enabled. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, a medium dynamically retaining a program for a short period of time, or other computer-readable recording media.

Furthermore, each functional block or various characteristics of the apparatuses used in the above-described embodiment may be implemented or performed on an electric circuit, for example an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor, a processor of known type, a controller, a micro-controller, or a state machine. The above-mentioned electric circuit may be configured with a digital circuit, or may be configured with an analog circuit. Furthermore, in a case that with advances in semiconductor technology, a circuit integration technology appears that replaces the present integrated circuits, a new integrated circuit based on the technology can be applied to one or multiple aspects of the present invention.

Note that the invention of the present patent application is not limited to the above-described embodiment. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

The embodiment of the present invention has been described in detail above referring to the drawings, but the specific configuration is not limited to the embodiment and includes, for example, an amendment to a design that falls within the scope that does not depart from the gist of the present invention. Furthermore, various modifications are possible within the scope of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

### INDUSTRIAL APPLICABILITY

The present invention can be preferably used in a base station apparatus, a terminal apparatus, and a communication method.

The present international application claims priority based on JP 2016-204152 filed on Oct. 18, 2016, and all the contents of JP 2016-204152 are incorporated in the present international application by reference.

### REFERENCE SIGNS LIST

1A Base station apparatus
2A, 2B Terminal apparatus
101 Higher layer processing unit
102 Control unit
103 Transmission unit
104 Reception unit
105 Transmit and/or receive antenna
106 Carrier sense unit
1011 Radio resource control unit
1012 Scheduling unit
1031 Coding unit
1032 Modulation unit
1033 Downlink reference signal generation unit
1034 Multiplexing unit
1035 Radio transmission unit
1041 Radio reception unit
1042 Demultiplexing unit
1043 Demodulation unit
1044 Decoding unit
201 Higher layer processing unit
202 Control unit
203 Transmission unit
204 Reception unit
205 Channel state information generating unit
206 Transmit and/or receive antenna
207 Carrier sense unit
2011 Radio resource control unit
2012 Scheduling information interpretation unit
2031 Coding unit
2032 Modulation unit
2033 Uplink reference signal generation unit
2034 Multiplexing unit
2035 Radio transmission unit
2041 Radio reception unit
2042 Demultiplexing unit
2043 Signal detection unit

1. A base station apparatus for communicating with a terminal apparatus, the base station apparatus comprising:
a carrier sense unit configured to secure a channel occupancy time by carrier sense; and
a transmission unit configured to transmit at least one subframe in the channel occupancy time,
wherein the transmission unit, in a case of communicating with the terminal apparatus only in an unlicensed band, transmits a preamble signal being a common signal in a cell by using an OFDM symbol in an anterior part of a first subframe of the at least one subframe.

2. The base station apparatus according to claim 1, wherein the preamble signal includes a cell-specific reference signal and a common downlink control channel.

3. The base station apparatus according to claim 1, wherein the carrier sense unit uses different energy detection threshold values for the carrier sense, between a case of communicating with the terminal apparatus in a licensed band and the unlicensed band, and a case of communicating with the terminal apparatus only in the unlicensed band.

4. A terminal apparatus for communicating with a base station apparatus, the terminal apparatus comprising:
a radio reception unit configured to receive multiple subframes from the base station apparatus; and
a demodulation unit configured to demodulate the multiple subframes received,
wherein the radio reception unit, in a case of communicating with the base station apparatus only in an unlicensed band, receives a preamble signal being a common signal in a cell by using an OFDM symbol in an anterior part of a first subframe of the multiple subframes,
the demodulation unit demodulates a data signal from an OFDM symbol other than the preamble signal, and
the preamble signal includes a cell-specific reference signal and a common downlink control channel.

5. A communication method of a base station apparatus for communicating with a terminal apparatus, the communication method comprising the steps of:
securing a channel occupancy time by carrier sense; and
transmitting at least one subframe in the channel occupancy time,
wherein the transmitting includes, in a case of communicating with the terminal apparatus only in an unlicensed band, transmitting a preamble signal being a common signal by using a cell in an OFDM symbol in an anterior part of a first subframe of the at least one subframe.

6. A communication method of a terminal apparatus for communicating with a base station apparatus, the communication method comprising the steps of:
wirelessly receiving multiple subframes from the base station apparatus; and
demodulating the multiple subframes received,
wherein the wirelessly receiving includes, in a case of communicating with the base station apparatus only in an unlicensed band, receiving a preamble signal being a common signal in a cell by using an OFDM symbol in an anterior part of a first subframe of the multiple subframes,
the demodulating includes demodulating a data signal from an OFDM symbol other than the preamble signal, and
the preamble signal includes a cell-specific reference signal and a common downlink control channel.
